(19) United States
(12) Patent Application Publication
(10) Pub. No.: US 2006/0202643 A1
(43) Pub. Date: Sep. 14, 2006

(54) Dynamic focus controller and control method of the same

(75) Inventor: Jae-wook Jung, Hwaseong-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/360,478

(22) Filed: Feb. 24, 2006

(30) Foreign Application Priority Data
Mar. 8, 2005 (KR) 2005-0019349

(51) Int. Cl. G09G 1/28

(52) U.S. Cl. 315/368.18

(57) ABSTRACT

The present invention relates to a dynamic focus controller of a television having a cathode ray tube (CRT), comprising a vertical parabola generator for generating a vertical parabola signal based on a vertical frequency of a television broadcast signal, an overlap parabola generator for outputting a horizontal and vertical overlap parabola signal by receiving a horizontal pulse based on a horizontal frequency of the television broadcast signal and the vertical parabola signal, a controller for controlling the overlap parabola generator so that the horizontal and vertical overlap parabola signal has a predetermined size, based on the horizontal frequency; and a focus signal output part applying a focus control signal to the CRT according to the horizontal and vertical overlap parabola signal input from the overlap parabola generator.

### CROSS-REFERENCE TO RELATED APPLICATIONS

This application claims the benefit under 35 U.S.C. §119(a) of Korean Patent Application No. 2005-19349, entitled “dynamic focus controller,” filed on Mar. 8, 2005, the entire contents of which are hereby incorporated by reference.

### BACKGROUND OF THE INVENTION

1. Field of the Invention

The present invention relates to a dynamic focus controller and a control method for a television using a cathode ray tube. More particularly, the present invention relates to a dynamic focus controller and a control method of the same for adjusting a focus control signal applied to a cathode ray tube according to a horizontal frequency of a broadcast signal.

2. Description of the Related Art

Cathode ray tubes (CRT) display images by focusing and accelerating a thermos electron discharged from a cathode of an electron gun, and collide it against a fluorescent surface to generate a pixel. The generation of such pixels results in the display of images.

Because a distance from an electron gun to an edge of a fluorescent surface is longer than a distance from electron gun to a center, the distance from the electron gun to the fluorescent surface is not uniform. Thus, when the focus of the two paths are attempted to be matched, the edge thereof is not in complete focus.

To overcome the above problem, a dynamic focus controller has been. presented.

As shown in FIG. 1, a conventional dynamic focus controller 1 comprises a vertical parabola generator 2, a horizontal parabola generator 3, an overlap parabola generator 4, and focus signal output part 5.

A waveform control signal generator 7 generates each pulse signal based on a horizontal frequency and a vertical frequency of the broadcast signal. The vertical parabola generator 2 and the horizontal parabola generator 3 generate respectively a vertical parabola signal and a horizontal parabola signal from the pulse signal.

Each of the parabola signals represents waveforms output from the vertical parabola generator 2 and the horizontal parabola generator 3. Furthermore, each of the parabola signals is overlapped in the overlap parabola generator 4, and applied to the CRT 6 via the focus signal generator 5 where the focus of the images displayed on the CRT 6 is adjusted through a grid electrode.

Herein, the pulse signal output from the waveform control signal generator 7 according to the horizontal frequency is changed or adjusted; accordingly, the horizontal parabola signal output from the horizontal parabola generator 3 also is changed. Therefore, if the input broadcast signal is changed, a focus distortion corresponding thereto appears.

Specifically as shown in conventional televisions, the greater the difference between the distance from the edge of the fluorescent surface to the electron gun and the greater the distance from the center of the fluorescent surface, the more the focus distortion occurs.

Therefore, the focus distortion occurs if the horizontal frequency of the signal being received changes such as when a television receives both an analog broadcast and a digital broadcast. Accordingly, there is a need for a reduction or elimination in focus distortion in a television.

### SUMMARY OF THE INVENTION

Accordingly, exemplary embodiments of the present invention provide a dynamic focus controller and a control method of the same that correct a focus distortion in case that a horizontal frequency of a broadcast signal received is changed.

The foregoing and other exemplary objects are substantially realized by providing a dynamic focus controller for a television having a CRT, comprising a vertical parabola generator for generating a vertical parabola signal based on a vertical frequency of a television broadcast signal, an overlap parabola generator for outputting a horizontal and vertical overlap parabola signal by receiving a horizontal pulse based on a horizontal frequency of the television broadcast signal and the vertical parabola signal, a controller for controlling the overlap parabola generator so that the horizontal and vertical overlap parabola signal has a predetermined size, based on the horizontal frequency, and a focus signal output part for applying a focus control signal to the CRT according to the horizontal and vertical overlap parabola signal input from the overlap parabola generator.

The overlap parabola generator comprises a coil for increasing a gain of the horizontal pulse, a transformer part for generating a horizontal parabola signal using a horizontal pulse passing through the coil, and overlapping the vertical parabola signal input with the horizontal parabola signal to output the horizontal and vertical overlap parabola signal, comprising a condenser in an end of a secondary of the transformer part, and a signal decline part decreasing a size of the horizontal pulse input to a primary of the transformer part.

The signal decline part comprises a switching part for powering ON/OFF according to the controller, and a reactor for performing at least one of connecting or interrupting to one of both ends of the primary of the transformer part according to the switching part of being turned ON/OFF so that the horizontal and vertical overlap parabola signal has a predetermined size.

The overlap parabola generator comprises an amplifier for connecting to the secondary of the transformer part and for amplifying the vertical parabola signal input.

The foregoing and other objects are substantially realized by providing a dynamic focus control method for a television having a CRT, comprising generating a vertical parabola signal based on a vertical frequency of a television broadcast signal, generating a horizontal and vertical overlap parabola signal by receiving a horizontal pulse based on a horizontal frequency of the television broadcast signal and the vertical parabola signal, controlling the horizontal and vertical overlap parabola signal to have a predetermined size based on the horizontal frequency, and applying a focus control signal to the CRT according to the horizontal and vertical overlap parabola signal.

Other objects, advantages, and salient features of the invention will become apparent from the detailed description, which, taken in conjunction with the accompanying drawings, discloses exemplary embodiments of the invention.

### BRIEF DESCRIPTION OF THE DRAWINGS

These and other aspects, features, and advantages of embodiments of the present invention will more apparent and more readily appreciated from the following detailed description, taken with reference to the accompanying drawings, in which:

FIG. 1 is a block diagram of a conventional dynamic focus controller;

FIG. 2 is a block diagram of a dynamic focus controller in accordance with an embodiment of the present invention;

FIG. 3a illustrates a horizontal parabola waveform;

FIG. 3b illustrates a vertical parabola-waveform;

FIG. 3c illustrates an overlap parabola waveform;

FIG. 4 is a circuit view of an overlap parabola generator and a controller of FIG. 2 in accordance with an embodiment of the present invention;

FIG. 5 is a circuit view of an overlap parabola generator and a controller of FIG. 2 in accordance with an embodiment of the present invention; and

FIG. 6 is a circuit view of an overlap parabola generator and a controller of FIG. 2 in accordance with an embodiment of the present invention.

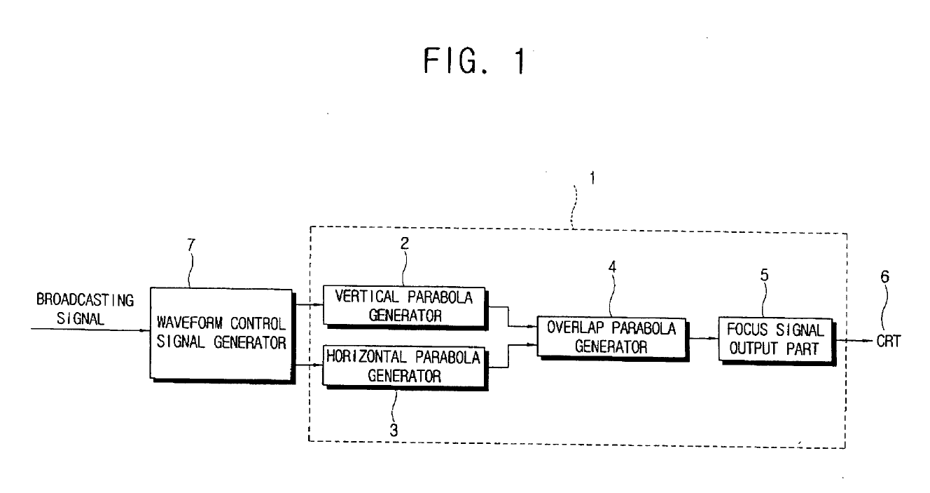

Throughout the drawings, like reference numerals will be understood to refer to like parts, components and structures.

### DETAILED DESCRIPTION OF EXEMPLARY EMBODIMENTS

The matters defined in the description such as a detailed construction and elements thereof, are provided to assist in a comprehensive understanding of the embodiments of the invention. Accordingly, those of ordinary skill in the art will recognize that various changes and modifications of the embodiments described herein can be made without departing from the scope and spirit of the invention.

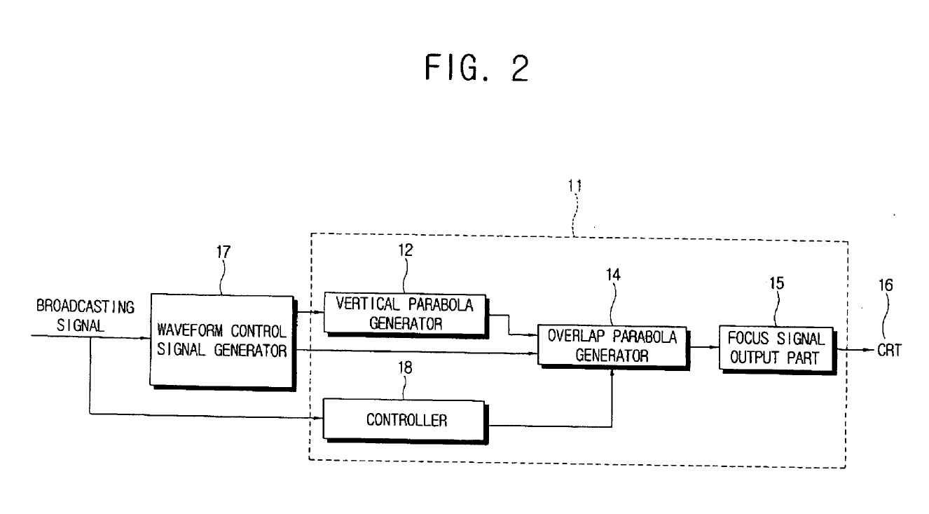

As shown in FIG. 2, a dynamic focus controller 11 in accordance with an embodiment of the present invention comprises a vertical parabola generator 12, an overlap parabola generator 14, a controller 18 and a focus signal output part 15.

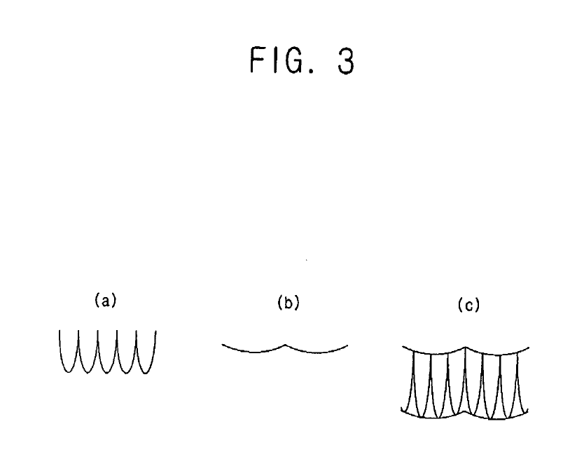

The vertical parabola generator 12 generates a vertical parabola signal, as shown in FIG. 3b, according to a vertical pulse of a waveform control signal generator 17 based on a vertical frequency of a broadcast signal.

Herein, the controller 18 controls the overlap parabola generator 14 so that a horizontal and vertical overlap parabola signal has a predetermined size based on a horizontal frequency of the broadcast signal.

The overlap parabola generator 14 receives a horizontal pulse based on the horizontal frequency of the broadcast signal and the vertical parabola signal and outputs the horizontal and vertical overlap parabola signal, as shown in FIG. 3c.

The focus signal output part 15 receives the horizontal and vertical overlap parabola signal of the overlap parabola generator 14 and applies the focus control signal to a CRT 16.

Herein, the focus signal output part 15 has a fly back transformer (FBT) and may output a high DC voltage input from a power supply (not shown).

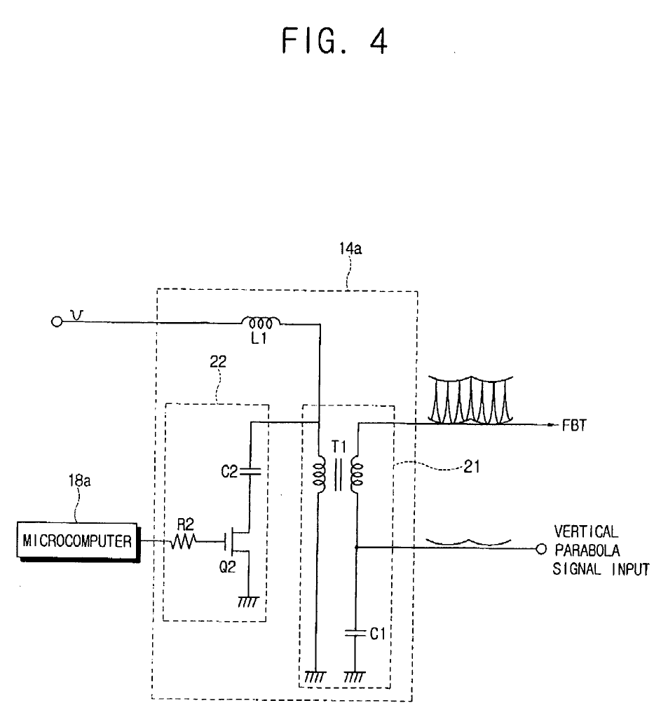

The overlap parabola generator 14 and the controller 18 of FIG. 2 in accordance with an embodiment of the present invention will be described in more detail with reference to FIG. 4.

As shown in FIG. 4, an overlap parabola generator 14a of a dynamic focus controller 11 according to a first embodiment of the present invention comprises a coil L1 for increasing a gain of a horizontal pulse; a transformer part 21 for generating a horizontal parabola signal, as shown in FIG. 3a, using the horizontal pulse passing through the coil L1, at the same time, overlapping a vertical parabola signal input with the horizontal parabola signal to output a horizontal and vertical overlap parabola signal, comprising a condenser C1 in an end of a secondary of the transformer part 21; and a signal decline part 22 for decreasing a size of the horizontal pulse input to a primary of the transformer part 21.

Herein, the horizontal pulses which may have a minus phase of a sine function are input to an input terminal of the overlap parabola generator 14a. The horizontal pulse having the gain changed according to a value of the coil L1 is induced to the secondary of the transformer T1 as a horizontal signal having a parabola form and overlaps the vertical parabola signal input via a condenser C1, and is output to the FBT.

It should be noted that the size of the horizontal pulse input to the primary of the transformer T1 may be changed based on whether the signal decline part 22 operates or not.

The controller 18 may be provided as a microcomputer 18a that applies an ON/OFF signal to a gate terminal of a field effect transistor (FET) Q2 through a resistance R2 of the signal decline part 22 based on the horizontal frequency. For example, in case that a common analog broadcasting signal with a horizontal frequency of 31.5 KHZ is received, the microcomputer 18a applies the OFF signal to the FET Q2 gate terminal without changing the horizontal parabola signal. If a digital broadcast with a horizontal frequency of 28.1 KHZ is received, the microcomputer 18a applies the ON signal to the FET Q2 gate terminal, and changes the signal input to the primary of the transformer T1 via a condenser C2.

Conventionally, if the horizontal frequency decreases, the size of the horizontal pulse input to the overlap parabola generator 14a becomes larger, so that the size of the horizontal and vertical overlap parabola signal becomes larger. Accordingly, the focus of the images is distorted. Therefore, the operation of the signal decline part 22 as described above needs to prevent the focus from being distorted.

Herein, the condenser C2 may employ an induced device such as a coil.

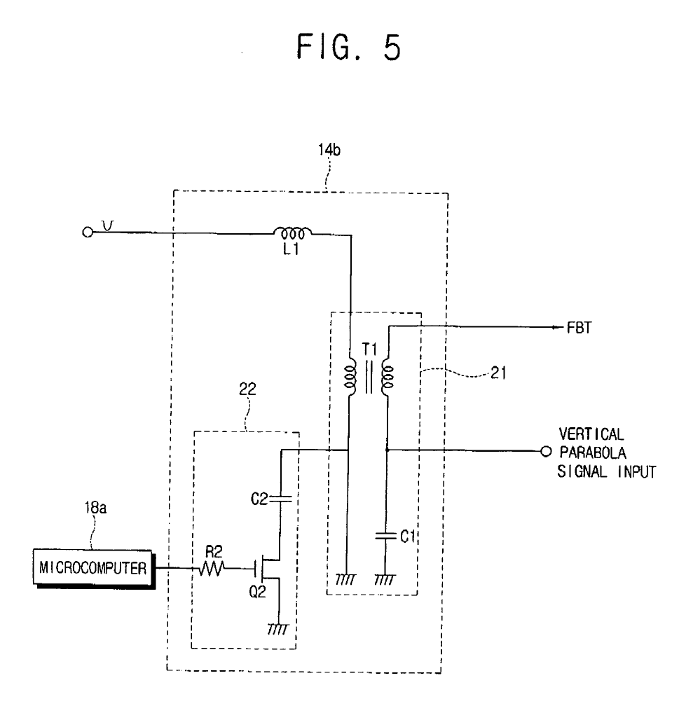

The signal decline part 22 may be connected to the other end of the primary of the transformer T1 differently from the position as shown in FIG. 5.

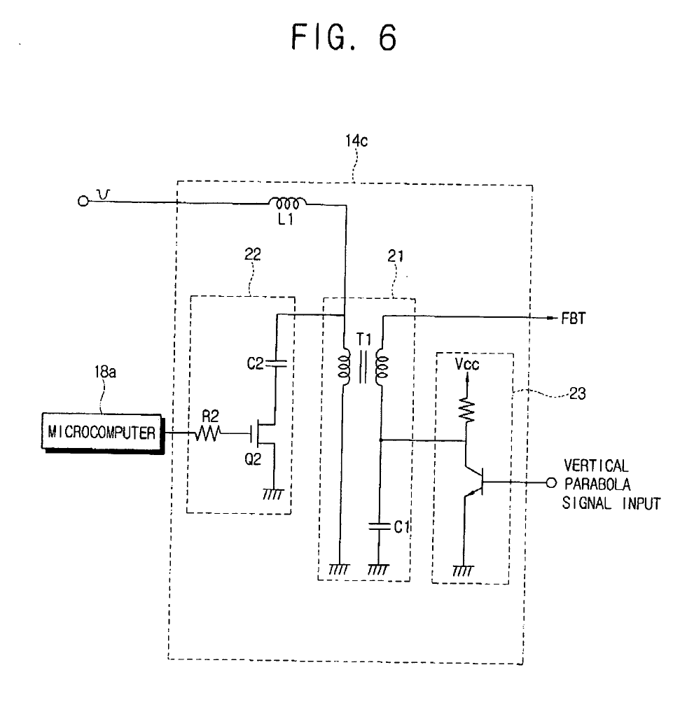

Further, as shown in FIG. 6, the overlap parabola generator 14c may comprise an amplifier 23 for amplifying the vertical parabola signal input from the vertical parabola generator 12.

As described above, the dynamic focus controller and the control method according to embodiments of the present invention can maintain the focus control signal in the predetermined size even if the horizontal frequency of the broadcasting signal is changed, thereby stabilizing the focus.

Further, the dynamic focus controller and the control method of the same can prevent the signal from exceeding a rating of the transformer, thereby reducing loss in the transformer.

While the invention has been shown and described with reference to exemplary embodiments thereof, it will be understood by those skilled in the art that various changes in form and details may be made therein without departing from the spirit and scope of the invention as defined by the appended claims.

What is claimed is:

1. A dynamic focus controller of a television having a cathode ray tube (CRT), comprising:
a vertical parabola generator for generating a vertical parabola signal based on a vertical frequency of a television broadcast signal;
an overlap parabola generator for outputting a horizontal and vertical overlap parabola signal by receiving a horizontal pulse based on a horizontal frequency of the television broadcast signal and the vertical parabola signal;
a controller for controlling the overlap parabola generator so that the horizontal and vertical overlap parabola signal has a predetermined size, based on the horizontal frequency; and
a focus signal output part for applying a focus control signal to the CRT according to the horizontal and vertical overlap parabola signal input from the overlap parabola generator.

2. The dynamic focus controller according to claim 1, wherein the overlap parabola generator comprises:
a coil for increasing a gain of the horizontal pulse;
a transformer part for generating a horizontal parabola signal using a horizontal pulse passing through the coil, and overlapping the vertical parabola signal input with the horizontal parabola signal to output the horizontal and vertical overlap parabola signal, comprising a condenser in an end of a secondary of the transformer part; and
a signal decline part for decreasing a size of the horizontal pulse input to a primary of the transformer part.

3. The dynamic focus controller according to claim 2, wherein the signal decline part comprises;
a switching part for being turned ON/OFF according to the controller; and
a reactor for connecting/disconnecting electrically with one of both ends of the primary of the transformer part according to the switching part being ON/OFF so that the horizontal and vertical overlap parabola signal has a predetermined size.

4. The dynamic focus controller according to claim 3, wherein the overlap parabola generator comprises an amplifier for connecting to the secondary of the transformer part and for amplifying the vertical parabola signal input.

5. The dynamic focus controller according to claim 1, wherein the focus signal output part comprises a fly back transformer.

6. The dynamic focus controller according to claim 1, wherein the focus signal output part outputs a large DC voltage.

7. The dynamic focus controller according to claim 3, wherein a size of a horizontal pulse is dependent on an on or off status of the signal decline part.

8. The dynamic focus controller according to claim 1, wherein the controller comprises a microcomputer.

9. A dynamic focus control method of a television having a cathode ray tube (CRT), comprising:
generating a vertical parabola signal based on a vertical frequency of a television broadcast signal;
generating a horizontal and vertical overlap parabola signal by receiving a horizontal pulse based on a horizontal frequency of the television broadcast signal and the vertical parabola signal;
controlling so that the horizontal and vertical overlap parabola signal has a predetermined size on based the horizontal frequency; and
applying a focus control signal to the CRT according to the horizontal and vertical overlap parabola signal.

10. The dynamic focus control method of claim 9, further comprising:
increasing a gain of the horizontal pulse;
generating a horizontal parabola signal using a horizontal pulse passing through a coil, and overlapping the vertical parabola signal input with the horizontal parabola signal to output the horizontal and vertical overlap parabola signal, comprising a condenser in an end of a secondary of a transformer part; and
decreasing a size of the horizontal pulse input to a primary of the transformer part.

11. The dynamic focus control method of claim 9, further comprising:
turning a switching part ON/OFF via a controller; and
electrically connecting/disconnecting a reactor with one of both ends of a primary of a transformer part according to a switching part being ON/OFF so that the horizontal and vertical overlap parabola signal has a predetermined size.

12. A computer readable medium having instructions for focusing a television having a cathode ray tube, comprising:
a first set of instructions for generating a vertical parabola signal based on a vertical frequency of a television broadcast signal;
a second set of instructions for generating a horizontal and vertical overlap parabola signal by receiving a horizontal pulse based on a horizontal frequency of the television broadcast signal and the vertical parabola signal;
a third set of instructions for controlling so that the horizontal and vertical overlap parabola signal has a predetermined size on based the horizontal frequency; and
a fourth set of instructions for applying a focus control signal to the CRT according to the horizontal and vertical overlap parabola signal.

13. The computer readable medium of claim 12, further comprising:
a fifth set of instructions for increasing a gain of the horizontal pulse;
a sixth set of instructions for generating a horizontal parabola signal using a horizontal pulse passing through a coil, and overlapping the vertical parabola signal input with the horizontal parabola signal to output the horizontal and vertical overlap parabola signal, comprising a condenser in an end of a secondary od a transformer part; and
a seventh set of instructions for decreasing a size of the horizontal pulse input to a primary of the transformer part.

14. The computer readable medium of claim 12, further comprising:
an eight set of instructions for turning a switching part ON/OFF via a controller; and
a ninth set of instructions for electrically connecting/disconnecting a reactor with one of both ends of a primary of a transformer part according to a switching part being ON/OFF so that the horizontal and vertical overlap parabola signal has a predetermined size.
